(19) United States
(12) Patent Application Publication
(10) Pub. No.: US 2026/0024504 A1
(43) Pub. Date: Jan. 22, 2026

(54) BACKLIGHT ADJUSTMENT METHOD, AND MEDIUM AND ELECTRONIC DEVICE

(71) Applicants: Beijing BOE Technology Development Co., Ltd., Beijing (CN); BOE Technology Group Co., Ltd., Beijing (CN)

(72) Inventors: Ruifeng QIN, Beijing (CN); Hao ZHANG, Beijing (CN); Chaoquan YAO, Beijing (CN); Peng HAN, Beijing (CN); Lili CHEN, Beijing (CN); Huidong HE, Beijing (CN); Qianwen JIANG, Beijing (CN); Weihua DU, Beijing (CN); Juanjuan SHI, Beijing (CN)

(73) Assignees: Beijing BOE Technology Development Co., Ltd., Beijing (CN); BOE Technology Group Co., Ltd., Beijing (CN)

(21) Appl. No.: 18/992,312

(22) PCT Filed: Mar. 14, 2024
(86) PCT No.: PCT/CN2024/081678

§ 371 Date: Jan. 8, 2025

(30) Foreign Application Priority Data
Apr. 19, 2023 (CN) 202310423183.7

(51) Int. Cl. G09G 3/34

(52) U.S. Cl. CPC G09G 3/3406; G09G 2310/0245; G09G 2320/064; G09G 2320/0646

(57) ABSTRACT

Provided is a method for adjusting backlight, including: when rendering a current image, determining backlight data corresponding to the current image; when transmitting the current image, updating, upon transmitting the current image for a first preset duration, the backlight data corresponding to the current image to a backlight driver chip; and when the updating of the backlight data corresponding to the current image is completed, controlling the backlight driver chip to turn on a backlight source, and adjusting backlight brightness based on the backlight data of the current image.

### CROSS-REFERENCE TO RELATED APPLICATIONS

The present application is a U.S. National Stage of International Application No. PCT/CN2024/081678, filed on Mar. 14, 2024, which is based upon and claims the priority to the Chinese Patent Application NO. 202310423183.7, entitled “BACKLIGHT ADJUSTMENT METHOD, MEDIUM AND ELECTRONIC DEVICE”, filed on Apr. 19, 2023, the entire contents of both of which are hereby incorporated by reference.

### TECHNICAL FIELD

The present disclosure relates to the field of display technologies, and in particular, to a method for adjusting backlight, a medium and an electronic device.

### BACKGROUND

In order to achieve a three-dimensional display effect, a refresh rate of display screens of virtual reality devices is typically higher than that of conventional display devices. The refresh rate of the display screen refers to the number of times an image displayed on the display screen is updated per second, and its unit is Hertz (Hz).

The backlight of the display screen is divided into zones, that is, for a bright part of a picture, the backlight of the current position should also be brighter, and for a dark part of the picture, the backlight brightness of the current position is low, thereby improving the contrast of the overall picture.

It should be noted that the information disclosed in the Background section above is only for enhancing the understanding of the background of the present disclosure, and thus may include information that does not constitute prior art known to those of ordinary skill in the art.

### SUMMARY

According to an aspect of the present disclosure, there is provided a method for adjusting backlight, and the method includes: when rendering a current image, determining backlight data corresponding to the current image; when transmitting the current image, updating, upon transmitting the current image for a first preset duration, the backlight data corresponding to the current image to a backlight driver chip; and when update of the backlight data corresponding to the current image is completed, controlling the backlight driver chip to turn on a backlight source, and adjusting backlight brightness based on the backlight data of the current image.

According to another aspect of the present disclosure, there is provided a computer-readable storage medium having a computer program stored thereon, which, when executed by a processor, implements the method provided in any aspect of the present disclosure.

According to yet another aspect of the present disclosure, there is provided an electronic device, including a processor and a memory configured to store executable instructions of the processor; wherein the processor is configured to execute the method provided in any aspect of the present disclosure by executing the executable instructions.

It should be noted that the above general description and the following detailed description are merely exemplary and explanatory and should not be construed as limiting of the disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure. Apparently, the drawings in the following description are only some embodiments of the present disclosure. For those of ordinary skill in the art, other drawings may be obtained based on these drawings without paying any creative effort.

FIG. 1 is a block diagram of a hardware connection of a display device according to an embodiment of the present disclosure.

FIG. 2 is a waveform diagram of a backlight signal and a display signal according to an embodiment of the present disclosure.

FIG. 3 is a workflow diagram of a system of a display device according to an embodiment of the present disclosure.

FIG. 4 is a flowchart of a method for adjusting backlight according to an embodiment of the present disclosure.

FIG. 5 is a block diagram of a hardware connection of another display device according to an embodiment of the present disclosure.

FIG. 6 is a schematic diagram of a process of delaying updating of backlight data by one frame according to an embodiment of the present disclosure.

FIG. 7 is a schematic diagram of another process of delaying updating of backlight data by one frame according to an embodiment of the present disclosure.

FIG. 8 is a schematic diagram of a process of adjusting a backlight position according to a refresh rate according to an embodiment of the present disclosure.

FIG. 9 is a block diagram of a hardware connection of yet another display device according to an embodiment of the present disclosure.

FIG. 10 is another workflow diagram of a system of a display device according to an embodiment of the present disclosure.

FIG. 11 is a flowchart of dividing and synthesizing layers of an image according to an embodiment of the present disclosure.

FIG. 12 is a schematic structural diagram of an electronic device according to an embodiment of the present disclosure.

In the figures: 1—processor, 2—display screen, 21—first display screen, 22—second display screen, 23—display driver chip, 3—backlight module, 31—first backlight module, 32—second backlight module, 33—backlight driver chip, 4—system, 41—application, 42—picture display device, 421—image processing module, 422—display driver module, 43—backlight adjustment device, 431—data processing module, 432—backlight driver module, 5—pulse width modulation module, 6—camera, 7—gyroscope, 800—electronic device, 810—processing unit, 820—storage unit, 821—random access storage unit, 822—cache storage unit, 823—read-only storage unit, 824—program/utility, 825—program module, 830—bus, 840—I/O interface, 850—network adapter, 900—external device.

### DETAILED DESCRIPTION

Example embodiments will now be described more fully with reference to the accompanying drawings. However, the example embodiments can be implemented in a variety of forms and should not be construed as being limited to examples set forth herein; rather, these embodiments are provided so that the present disclosure will be more complete and comprehensive so as to convey the idea of the example embodiments to those skilled in this art. The same reference numerals in the drawings denote the same or similar structures, and the repeated description thereof will be omitted. In addition, the drawings are merely schematic representations of the present disclosure and are not necessarily drawn to scale.

Although the relative terms such as “above” and “below” are used in the specification to describe a relative relationship of one component to another component shown, these terms are only for convenience in this specification, for example, according to an example direction shown in the drawings. It will be understood that if a device shown is flipped upside down, a component described as “above” will become the component “below” another component. When a structure is “on” another structure, it may mean that the structure is integrally formed on the other structure, or that the structure is “directly” disposed on the other structure, or that the structure is “indirectly” disposed on the other structure through other structures.

The terms “one”, “a”, “the”, “said”, and “at least one” are used to indicate that there are one or more elements/components or the like; the terms “include” and “contain” are used to indicate an open meaning of including and means that there may be additional elements/components/etc. in addition to the listed elements/components/etc.; and the terms “first”, “second” and “third” etc. are used only as markers, and do not limit the number of objects.

In a display device, a zone-controlled backlight is used, and each zone has brightness data. That is, for a bright part of a picture, the backlight of the current position should also be brighter, and for a dark part of the picture, the backlight brightness of the current position is low, thereby improving the contrast of the overall picture. If the backlight does not correspond to the picture, the contrast will be reduced, and the picture may even look weird.

Embodiments of the present disclosure provide a method for adjusting backlight. As shown in FIGS. 1 to 11, the method includes the following content.

In step S10, when a current image is rendered, backlight data corresponding to the current image is determined.

In step S20, when the current image is transmitted, the backlight data corresponding to the current image is updated to a backlight driver chip after the current image is transmitted for a first preset duration.

In step S30, when update of the backlight data corresponding to the current image is completed, the backlight driver chip is controlled to turn on a backlight source, and backlight brightness is adjusted based on the backlight data of the current image.

After the rendering and transmission of the current image, as well as the calculation and update of its backlight data are completed, the backlight source is then turned on, so that when the backlight source is turned on, the picture is displayed as the current image, and the backlight data is also the backlight data of the current image, so as to achieve synchronization between the backlight and the displayed picture.

The method for adjusting the backlight involved in the embodiment of the present disclosure is described in detail below with reference to specific embodiments.

As shown in FIG. 1, the backlight of the display device is controlled in zones. The display device may include a processor 1, a display screen 2 and a backlight module 3. The backlight module 3 may include a backlight driver chip 33 and a backlight board. The display screen 2 is connected to the processor 1 via a Mobile Industry Processor Interface (MIPI). The processor 1 sends an image data signal (mipi) transmitted by a MIPI protocol to the display screen 2, and the display screen 2 receives the image data signal sent by the processor and feeds back a backlight on reference signal (TE) to the processor 1. The display screen sends a synchronization signal to the backlight driver chip, and the backlight driver chip 33 receives the synchronization signal (vsync) sent by the display screen 2. After the synchronization signal is received, a backlight signal is sent to the backlight source under the control of an internal timing of the backlight driver chip 33. The backlight signal controls the backlight source to turn on. The processor 1 controls the backlight driver chip 33 through a Serial Peripheral Interface (SPI). Alternatively, the processor 1 can also be connected to the backlight driver chip 33 via an I2C interface.

The display device may include two display screens 2 and two backlight modules 3, the two display screens 2 are respectively a first display screen 212 and a second display screen 222, and the two backlight modules 3 are respectively a first backlight module 313 and a second backlight module 323. The processor 1 may perform image processing and display driving of the first display screen 212 through a first image data signal (mipi1), and trigger, through a first synchronization signal (vsync1), a first backlight driver chip 33 of the first backlight module 313 to operate. The processor 1 may perform image processing and display driving of the second display screen 222 through a second image data signal (mipi2), and trigger, through a second synchronization signal (vsync2), a second backlight driver chip 33 of the second backlight module 323 to operate.

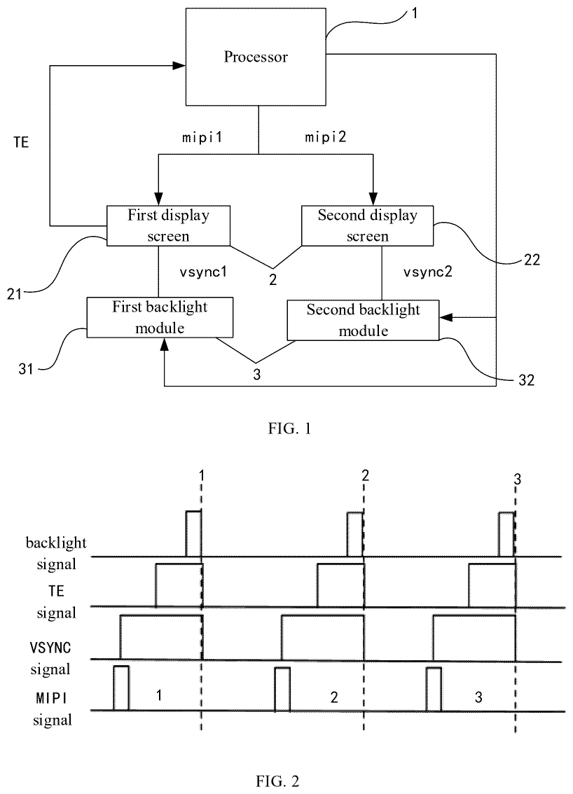

As shown in FIG. 2, an image data signal controls the timing of the image transmission of the processor 1, the low level represents that the processor 1 transmits an image to a display driver chip 23, and the high level represents a blanking area. A synchronization signal controls the timing of refreshing the image inside the display driver chip 23 (e.g., a Display Driver Integrated Circuit (DDIC)), the low level represents refreshing the image, and the high level represents the blanking area. A backlight on reference signal is generated by the display driver chip 23. A rising edge of the backlight on reference signal is a backlight on reference time, and a falling edge of the backlight on reference signal is used as an interruption trigger signal of the backlight driver chip 33. A backlight signal controls the on and off of the backlight source, the high level represents the backlight on, and the low level represents the backlight off. The image data signal, the synchronization signal, the backlight on reference signal and the backlight signal jointly affect the synchronization of the image display and the backlight switch.

Generally, the image data signal and the synchronization signal are exactly the same. In virtual reality devices, if they are the same, the backlight will be turned on when the image transmission is not completed, the liquid crystal has not rotated to the right position yet, and a ghosting will be seen. Accordingly, a time from a rising edge of the synchronization signal to a rising edge of the backlight signal is a time left for the liquid crystal to rotate herein, and this time is a response speed of the liquid crystal. It is necessary to ensure that the backlight occurs at the end of a high level area of the synchronization signal.

For example, a brightness value of each liquid crystal pixel is 0-255, and different values correspond to different liquid crystal deflection angles. If the synchronization signal is consistent with the image data signal, a backlight on position (or a backlight on time) is unchanged, which is at the end of the high level of the synchronization signal. The rising edge of the image data signal is approximately at a time when the scan of the last line of the image on the display screen is completed. After the scan is completed, the liquid crystal begins to deflect. A high level time of the image data is short, such as 1 ms. After the last line of liquid crystal on the display screen is deflected for Ims, the backlight source is turned on. The liquid crystal cannot be deflected into place within Ims. If a new brightness value of a pixel is 100, and an original brightness value is 60, after Ims, the brightness may be only 80, which will cause inconsistency with the actual brightness value.

The backlight is divided into zones, that is, for a bright part of a picture, the backlight of the current position should also be brighter, and for a dark part of the picture, the backlight brightness of the current position is low, thereby improving the contrast of the overall picture. If the backlight does not correspond to the picture, the contrast will be reduced, and the picture may even look weird. Therefore, it is necessary to strictly control the consistency between the current picture display and the backlight.

Therefore, in this embodiment, the rising edge of the synchronization signal of the current image is located after the rising edge of the image data signal of the next frame image of the current image and before the falling edge of the image data signal of the next frame image of the current image; the falling edge of the synchronization signal of the current image is located after the falling edge of the image data signal of the next frame image of the current image and before the rising edge of the image data signal of the second frame image behind the current image; the rising edge of the backlight on reference signal of the current image is located after the rising edge of the synchronization signal of the current image; the falling edge of the backlight on reference signal of the current image is synchronized with the falling edge of the synchronization signal of the current image; the rising edge of the backlight signal of the current image is located after the rising edge of the backlight on reference signal of the current image; and the falling edge of the backlight signal of the current image is synchronized with the falling edge of the backlight on reference signal of the current image.

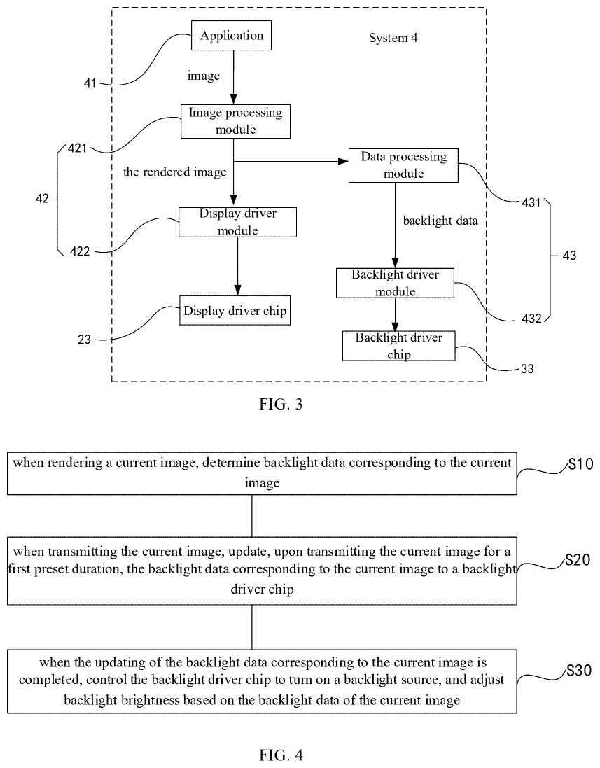

As shown in FIG. 3, the processor 1 runs an application 41 and can display the picture through a picture display device 42. The picture display device 42 includes an image processing module 421 and a display driver module 422. Based on an instruction of the application 41, the image processing module 421 renders the current image and transmits it to the display driver module 422. The display driver module 422 controls the display driver chip to display the rendered current image.

The processor 1 runs the application 41, and can adjust the backlight through a backlight adjustment device 43. The backlight adjustment device 43 includes a data processing module 431 and a backlight driver module 432. The data processing module 431 calculates the backlight data corresponding to the current image and sends it to the backlight driver module 432. The backlight driver module 432 updates the backlight data corresponding to the current image to the backlight driver chip 33 and controls the backlight driver chip 33 to turn on the backlight source. It should be noted that the data processing module 431 can adopt a Software Development Kit (SDK).

Through the method for adjusting the backlight shown in FIG. 4, the consistency of the picture display and the backlight is achieved. In the step S10, the image processing module 421 can render the current image, and the data processing module 431 can determine the backlight data corresponding to the current image, and send it to the backlight driver module 432. In the step S20, the image processing module 421 can transmit the current image, and after a falling edge of a backlight on reference signal of the previous frame image of the current image, the backlight driver module 432 can refresh the current image to the display screen, and update the backlight data corresponding to the current image to the backlight driver chip 33, and the display driver module 422 can refresh the current image to the display driver chip. In the step S30, before a falling edge of a backlight on reference signal of the current image, the backlight driver module 432 controls the backlight driver chip to send a backlight signal of the current image, and adjusts the backlight brightness based on the backlight data of the current image. Therefore, when the backlight source is turned on, the picture is displayed as the current image, and the backlight data is also the backlight data of the current image, so as to achieve the synchronization of the backlight and the picture display.

It can be understood that the first preset duration is a time difference between the falling edge of the image data signal of the current image and the falling edge of the backlight on reference signal of the previous frame image of the current image. A duration required to complete the update of the backlight data corresponding to the current image is a time difference between the falling edge of the backlight on reference signal of the previous frame image of the current image and the falling edge of the backlight on reference signal of the current image.

Specifically, in a low-level waveform segment of the image data signal within a first cycle, the current image is rendered and the backlight data corresponding to the rendered current image is determined; in a low-level waveform segment of the synchronization signal between a first time and a second time, the previous frame image of the current image is refreshed to the display screen; and in a high-level waveform segment of the backlight signal between the first time and the second time, the backlight source is turned on, and the previous frame image of the current image is displayed.

In a low-level waveform segment of the image data signal within a second cycle, the current image is transmitted, the next frame image of the current image is rendered, and the backlight data corresponding to the rendered next frame image of the current image is determined. In a low-level waveform segment of the synchronization signal between a second time and a third time, the current image is refreshed to the display screen. In a high-level waveform segment of the backlight signal between the second time and the third time, the backlight source is turned on, and the current image is displayed.

It should be noted that the first time is the falling edge of the backlight on reference signal of the second frame image before the current image, and the first time triggers a first interruption of the light emission of the backlight source. The second time is the falling edge of the backlight on reference signal of the previous frame image of the current image, and the second time triggers a second interruption of the light emission of the backlight source. The third time is the falling edge of the backlight on reference signal of the current image, and the third time triggers a third interruption of the light emission of the backlight source.

It should be noted that the first cycle represents a time period for rendering the current image, and the second cycle represents a time period for rendering the next frame image of the current image. The first cycle and the second cycle here only represent an order of precedence, and do not represent a specific cycle of the image data signal. The second cycle is immediately after the first cycle. The first cycle may be a first cycle of the image data signal, and the second cycle may be a second cycle of the image data signal. The first cycle may also be a third cycle of the image data signal, and the second cycle may also be a fourth cycle of the image data signal.

As shown in FIG. 5, the display device may further include a pulse width modulation (PWM) module 5, which provides a pulse width modulation signal to the backlight module 3. Specifically, the pulse width modulation signal is transmitted to the backlight driver chip 33, and the backlight driver chip 33 controls a backlight on time in the current image according to a frequency of the pulse width modulation signal. For two display screens 2 and two backlight modules 3, the processor 1 may control the pulse width modulation module 5 to provide pulse width modulation signals to the first backlight module 313 and the second backlight module 323, respectively.

A relationship between the frequency of the pulse width modulation signal and the refresh rate (Frames Per Second, FPS) is that pulse width modulation=512*refresh rate. As long as the frequency of the pulse width modulation signal is the same, the backlight on time is the same. The pulse width modulation module 5 may be a power management integrated circuit (PowerManagementIC, PMIC) in the processor 1, or may be an independent external module. When the refresh rate changes, the overall brightness of the backlight will change, so it is necessary to eliminate the influence of the refresh rate on the backlight brightness. The backlight brightness mainly depends on the brightness of the backlight source, so it is necessary to control the brightness of the backlight source.

When the pulse width modulation module 5 may be the power management integrated circuit (PowerManagementIC, PMIC) in the processor 1, it is impossible to generate so many precise pulse width modulation signal frequencies. For a variable refresh rate, a fixed pulse width modulation frequency may be used. When the refresh rate is switched, the display driver notifies the backlight driver module 432, and the backlight driver module 432 performs corresponding processing based on the refresh rate. The backlight driver module 432 needs to compensate the backlight data and determine a backlight duration based on the compensated backlight data. When an external pulse width modulation module 5 is used, the external pulse width modulation module 5 can directly generate the required frequency to solve the problem of the backlight compensation.

When the frequency of the pulse width modulation signal is fixed, a control process of the brightness of the backlight source is as follows. The refresh rate of the current image is acquired; a compensation coefficient γ of the current image is determined based on the refresh rate of the current image and a preset first correspondence, and the first correspondence is a correspondence between different refresh rates and different compensation coefficients; the backlight data of the current image is compensated, so that the backlight driver chip 33 determines brightness of the backlight source based on the compensated backlight data of the current image. The first correspondence is shown in Table 1.

TABLE 1
Correspondence between refresh rate and compensation coefficient

| | | | | |
|---|---|---|---|---|
| Refresh rate | α0 | α1 | . . . | αn |
| Compensation | γ0 | γ1 | . . . | γn |
| coefficient | | | | |

When the frequency of the pulse width modulation signal may vary, a control process of the brightness of the backlight source is as follows. The refresh rate of the current image is acquired; the frequency of the pulse width modulation signal is updated based on the refresh rate of the current image; and the updated pulse width modulation signal is sent to the backlight driver chip 33, so that the backlight driver chip 33 determines the brightness of the backlight source according to the updated frequency of the pulse width modulation signal.

Regardless of the control method used for the brightness of the backlight source, it was found in actual measurements that when the refresh rate varies, the eye can see an instantaneous change in brightness, even though the brightness before and after the refresh rate change is almost unchanged when measured by an instrument. After experiments, it was found that delaying the backlight change by one frame will effectively reduce the brightness change perceived by the human eye.

Therefore, when the refresh rate of the current image is updated, the backlight compensation coefficient of the current image is updated with a delay of one frame.

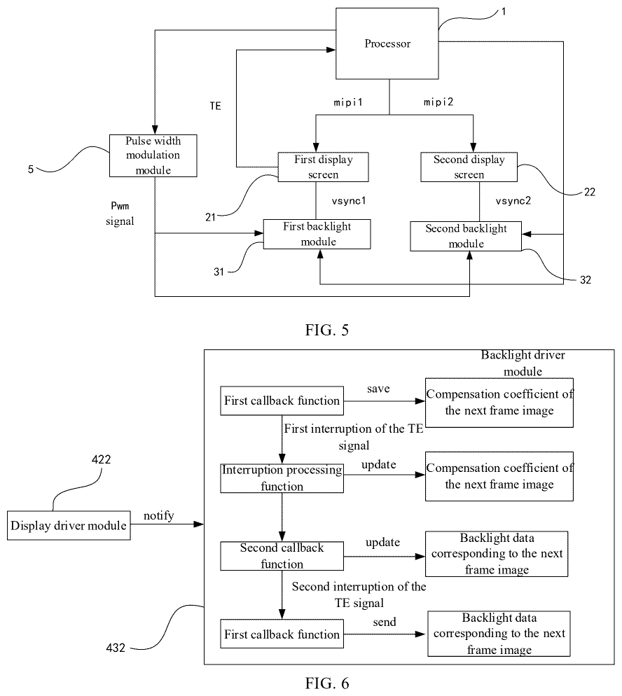

As shown in FIG. 6, when a control method for compensating the backlight data is adopted, the delay process is as follows.
1) When the refresh rate of the picture varies, the updated compensation coefficient γ of the current image is saved, and a flag scal_need_update for updating the compensation coefficient is set to true.
2) When the backlight of the current image is interrupted, the compensation coefficient γ of the current image is updated based on the flag scal_need_update.
3) The backlight data corresponding to the current image is determined based on the compensation coefficient γ of the current image, and the stored backlight data corresponding to the current image is updated. After the processing is completed, the flag scal_need_update is cleared.
4) When the backlight of the next frame image of the current image is interrupted, the backlight data corresponding to the current image is sent.

The backlight driver module has an interruption processing function, a first callback function and a second callback function. The interruption processing function is configured to update the compensation coefficient γ of the current image based on the flag scal_need_update when the backlight of the current image is interrupted. The interruption processing function is further configured to send the backlight data corresponding to the current image when the backlight of the next frame image of the current image is interrupted.

The first callback function is configured to, when the refresh rate of the picture varies, save the updated compensation coefficient γ of the current image, and set the flag scal_need_update for updating the compensation coefficient to true. The second callback function is configured to determine the backlight data corresponding to the current image based on the compensation coefficient γ of the current image, and update the stored backlight data corresponding to the current image, and clear the flag scal_need_update after the processing is completed.

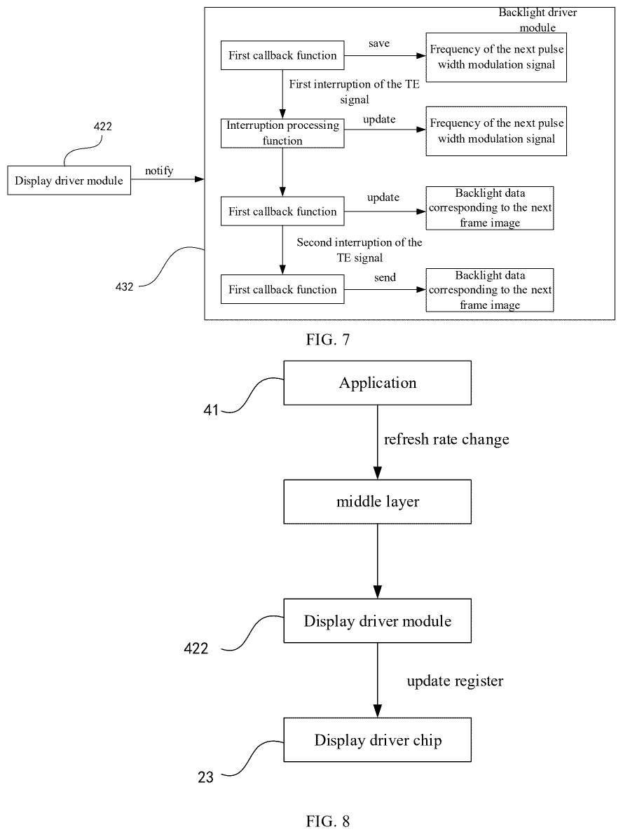

As shown in FIG. 7, when the control method for the frequency of the pulse width modulation signal is adopted, the delay process is as follows.
1) When the refresh rate of the picture varies, the frequency of the pulse width modulation signal of the current image is saved, and the flag scal_need_update for updating the frequency of the pulse width modulation signal is set to true.
2) When the backlight of the current image is interrupted, the frequency of the pulse width modulation signal of the current image is updated based on the flag scal_need_update.
3) The backlight data corresponding to the current image is determined based on the frequency of the pulse width modulation signal of the current image, and the stored backlight data corresponding to the current image is updated. After the processing is completed, the flag scal_need_update is cleared.
4) When the backlight of the next frame image of the current image is interrupted, the backlight data corresponding to the current image is sent.

The backlight driver module has an interruption processing function, a first callback function and a second callback function. The first callback function and the interruption processing function are configured to update the frequency of the pulse width modulation signal of the current image based on the flag scal_need_update when the backlight of the current image is interrupted. The interruption processing function is further configured to send the backlight data corresponding to the current image when the backlight of the next frame image of the current image is interrupted. The first callback function is configured to, when the refresh rate of the picture varies, save the frequency of the pulse width modulation signal of the current image and set the flag scal_need_update for updating the frequency of the pulse width modulation signal to true. The second callback function is configured to determine the backlight data corresponding to the current image based on the frequency of the pulse width modulation signal of the current image, and update the stored backlight data corresponding to the current image, and clear the flag scal_need_update after the processing is completed.

Through the above two methods, the update of the backlight data of the picture can be delayed by one frame. When the refresh rate of the picture does not vary, the interruption processing function sends the backlight data after each interruption of the light emission of the backlight source. It should be noted that the falling edge of the backlight on reference signal triggers the interruption of the light emission of the backlight source.

As shown in FIG. 8, in the case of a dynamic refresh rate, it is still necessary to ensure that at each refresh rate, the backlight signal occurs at the end of the synchronization signal. There is a response signal between the display driver chip 23 (e.g., a Display Driver Integrated Circuit (DDIC)) and the backlight driver chip 33, and the backlight driver chip 33 turns on the backlight based on this response signal. When the application 41 changes the refresh rate, some registers need to be updated to adjust the position of the response signal to change the position of the backlight to meet the backlight requirements of the frame image.

When the display device is a virtual display device, the display screen 2 requires a high refresh rate to reduce latency and dizziness. However, a high refresh rate will also increase power consumption, greatly reducing the battery life of the virtual reality device. There are usually different application modes, including but not limited to a viewing mode, a normal mode and a game mode, and refresh rates and rendering resolutions used in the three different modes are different. It is possible to consider associating a rotation speed of the virtual reality device with the refresh rate and the rendering resolution, respectively, to determine a correspondence between a refresh rate level and a rotation speed range, as well as a correspondence between the rotation speed range and a reduction ratio of the rendering resolution.

The following is an explanation of an association process between the rotation speed and the refresh rate. Different rotation speeds of the virtual reality device are set to V0, V1 . . . . Vn, refresh rate levels are set to α0, α1, . . . αn, and the correspondence between the refresh rate level and the rotation speed range is determined. The correspondence is shown in Table 2:

TABLE 2
Correspondence between refresh rate
levels and rotation speed ranges

| | | | | |
|---|---|---|---|---|
| Speed | V0-V1 | V1-V2 | . . . | Vn-1-Vn |
| Refresh rate | α0 | α1 | . . . | αn |

The following is an explanation of an association process between the rotation speed and the rendering resolution. The rendering resolution is scaled down proportionally according to the rotation speed of the virtual reality device. For example, the rendering resolution of the display screen 2 is R0, R0 is scaled down to R1 by 0.9 (the length and width are both reduced to 0.9 of the original), and R0 is scaled down to R2 by 0.8. Similarly, the rendering resolution is divided into R1 . . . . Rn according to the reduction ratio, and the correspondence between the rotation speed range and the reduction ratio of the rendering resolution is determined. The correspondence is shown in Table 3:

TABLE 3
Correspondence between reduction ratio of rendering
resolution and rotation speed range

| | | | | |
|---|---|---|---|---|
| Rotation speed | V0-V1 | V1-V2 | . . . | Vn-1-Vn |
| Rendering | R0 | R1 | . . . | R |
| Resolution | | | | |

The correspondence between the refresh rate level and the rotation speed range is defined as a second correspondence, and the correspondence between the rotation speed range and the reduction ratio of the rendering resolution is defined as a third correspondence. The rotation speed range in the second correspondence is the same as or different from the rotation speed range in the third correspondence. For example, as shown in Table 2 and Table 3, the speed ranges corresponding to α0 and R0 may be V0-V1; or the speed range corresponding to α0 may be V0-V1, and the speed range corresponding to R0 may be V0-V2.

In the viewing mode, when the head turns, the picture does not turn with it, and a fixed refresh rate and a fixed rendering resolution are used in this case. In the normal mode, a normal correspondence is used. In the game mode, it is sensitive to the refresh rate. In the correspondence table used in this case, the refresh rate is larger than that in the normal mode. A gyroscope 7 may be controlled to acquire the rotation speed of the virtual reality device; and the refresh rate of the current image is determined based on the rotation speed and the second correspondence. The rendering resolution of the current image is determined based on the rotation speed and the third correspondence. Accordingly, the refresh rates and the rendering resolutions of the current image in the virtual reality device are determined in different modes.

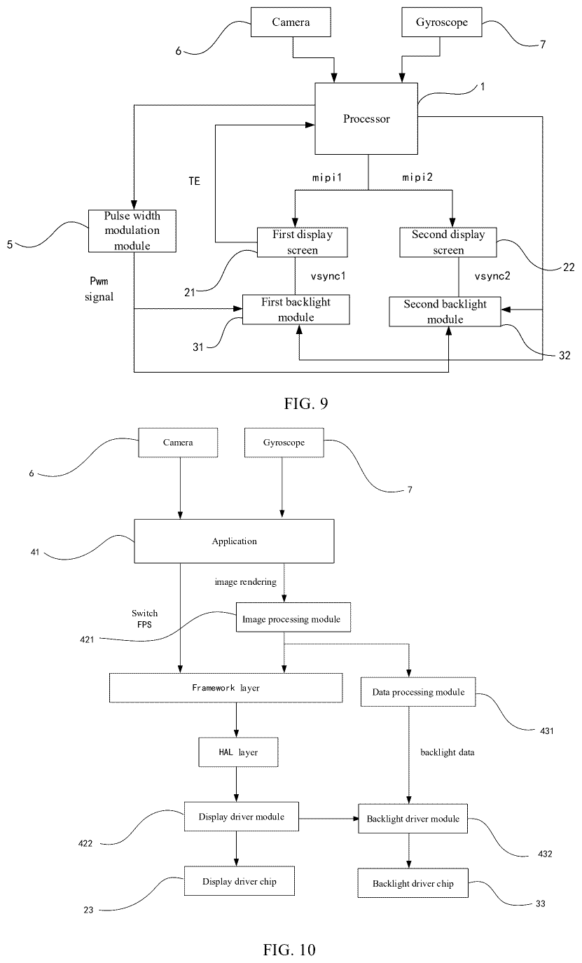

According to the rotation speed acquired by the gyroscope 7, different refresh rates are switched to save power consumption as much as possible while maintaining the viewing effect. For example, in the game mode, the head moves faster, and the picture of the virtual reality device will rotate quickly with the head, and the overall rendering resolution of the picture can be appropriately reduced. As shown in FIG. 9, the display device may further include a gyroscope 7, and the processor 1 acquires measurement data through the gyroscope 7 and calculates the rotation speed of the virtual display device.

As shown in FIG. 9, the display device may further include a camera 6, and the processor 1 controls the camera 6 to shoot the eye and acquire the captured image of the eye. The gaze area of the current image is determined in the display screen 2 through a gaze point algorithm. The virtual reality device may be a VR helmet, and the camera 6 may be provided in the VR helmet. The gaze area of the current image is defined as a high-definition area, and the remaining area other than the gaze area of the current image is a non-high-definition area, and the high-definition area and the non-high-definition area use different rendering resolutions.

Since rendering requires the use of a graphics processor 1 (e.g., a Graphics Processing Unit (GPU)), the higher the rendering resolution of the current image, the greater the resource consumption of the image processor 1 and the greater the power consumption. The non-high-definition area does not need to be very clear because only the peripheral vision of the eye can see it, so a lower rendering resolution is used, thereby reducing the overall resource consumption of the image processor 1 and reducing the power consumption.

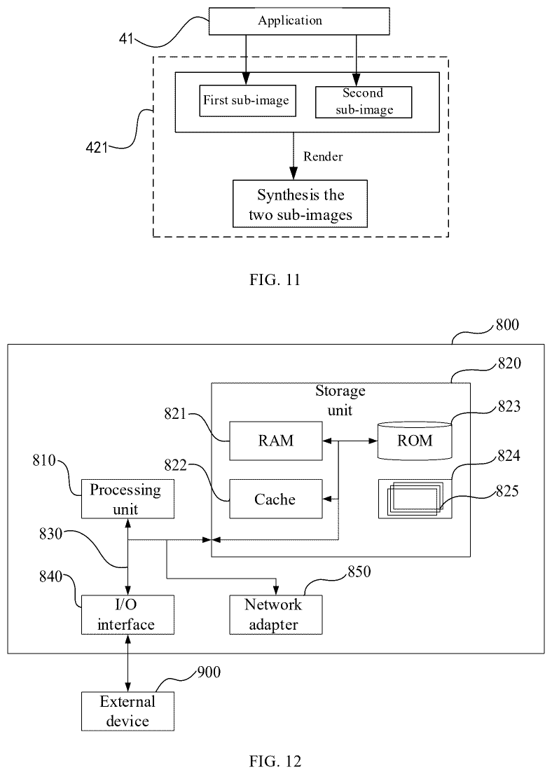

As shown in FIGS. 10 and 11, the displayed picture is usually composed of different layers, and the system 4 finally synthesizes the individual layers into a whole picture. Generally, the main picture of the system 4 has only one layer. Taking the current image as an example, and two different layers are used in the high-definition area and the non-high-definition area of the current image. The high-definition area corresponds to a first sub-image, and the non-high-definition area corresponds to a second sub-image, so that different rendering resolutions can be used for rendering the two different layers, and the rendered different layers are synthesized into a whole image, that is, the current image. It should be noted that the system here refers to an operating system, which may be an Android operating system, a Windows operating system, or an iOS operating system.

The high-definition area and the non-high-definition area use two different layers, so after rendering, two sub-images will be obtained. The two sub-images are calculated by different algorithms to obtain two backlight data groups, and the two backlight data groups are combined into one backlight data group. Since the backlight of the display screen 2 is divided in zones, a local backlight adjustment algorithm (e.g., a local dimming algorithm) is used to determine the backlight data of different areas of the display screen 2. The local backlight adjustment algorithm is divided into two versions, that is, a fine version and a coarse version. The fine version takes a long time, but the calculation result is more accurate, while the coarse version takes a short time and the calculation result is less accurate. The high-definition area uses a fine version algorithm, and the non-high-definition area uses the coarse version algorithm, thereby reducing the overall backlight data calculation time and the resource consumption of the central processing unit 1, thereby achieving the purpose of reducing power consumption.

When the refresh rate is switched, the display driver module 422 notifies the backlight driver module 432, and the backlight driver module 432 makes, based on the refresh rate change, corresponding adjustments to the compensation coefficient γ or the frequency of the pulse width modulation signal, thereby changing the brightness of the backlight source.

Embodiments of the present disclosure also provide a computer-readable storage medium, which can be implemented in the form of a program product, which includes program codes. When the program product is run on an electronic device, the program codes are configured to cause the electronic device to perform the steps according to various example embodiments of the present disclosure described in the above-mentioned “example methods” section of the present specification. In an embodiment, the program product may be implemented as a portable compact disc read-only memory (CD-ROM) and include program codes, and may be executed on an electronic device, such as a personal computer. However, the program product of the present disclosure is not limited thereto. The readable storage medium may be any tangible medium containing or storing a program, and the program may be used by an instruction execution system, apparatus, or device, or the program may be used in combination with an instruction execution system, apparatus, or device.

The program product may adopt any combination of one or more readable mediums. The readable medium may be a readable signal medium or a readable storage medium. The readable storage medium may be, for example, but is not limited to, an electronic, magnetic, optical, electromagnetic, infrared, or semiconductor system, apparatus, or device, or any combination thereof. More specific examples (non-exhaustive examples) of readable storage media include: electrical connection with one or more wires, portable disk, hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination of the foregoing.

The computer-readable signal medium may include a data signal in baseband or propagated as part of a carrier wave, which carries readable program codes. Such a propagated data signal may have many forms, including but not limited to an electromagnetic signal, an optical signal, or any suitable combination of the foregoing. The readable signal medium may also be any readable medium other than a readable storage medium, and the readable medium may send, propagate, or transmit a program that is used by an instruction execution system, apparatus, or device, or that is used in combination with an instruction execution system, apparatus, or device.

The program codes contained on the readable medium may be transmitted using any appropriate medium, including but not limited to wireless, wired, optical fiber, RF, etc., or any suitable combination of the foregoing.

The program codes for performing the operations of the present disclosure can be written in any combination of one or more programming languages, which include object-oriented programming languages, such as Java, C++, and so on. The programming languages further include conventional procedural programming language, such as “C” or a similar programming language. The program codes can be executed entirely on the user computing device, can be executed partly on the user device, can be executed as an independent software package, can be executed partly on the user computing device and partly on a remote computing device, or can be executed entirely on the remote computing device or a server. In the case of a remote computing device, the remote computing device can be connected to the user computing device through any kind of network, including a local area network (LAN) or a wide area network (WAN), or the remote computing device can be connected to an external computing device, for example, through the Internet provided by the Internet service providers.

As shown in FIG. 12, the electronic device 800 is shown in the form of a general-purpose computing device. The components of the electronic device 800 may include, but are not limited to, at least one processing unit 810, at least one storage unit 820, and a bus 830 connecting different system components (including the storage unit 820 and the processing unit 810).

The storage unit stores program codes, and the program codes can be executed by the processing unit 810, so that the processing unit 810 executes steps of various example embodiments according to the present disclosure described in the “example methods” section of the present specification. For example, the processing unit 810 may perform any one or more of the method steps in FIG. 4.

The storage unit 820 may include a volatile storage unit, such as a random access storage unit (RAM) 821 and/or a cache storage unit 822, and may further include a read-only storage unit (ROM) 823.

The storage unit 820 may further include a program/utility tool 824 having a set (at least one) of program modules 825. Such program modules 825 include, but are not limited to, an operating system, one or more application programs, other program modules, and program data. Each or some combination of these examples may include an implementation of a network environment.

The bus 830 may include a data bus, an address bus and a control bus.

The electronic device 800 may also communicate with one or more external devices 900 (such as a keyboard, a pointing device, a Bluetooth device, etc.). Such communication can be performed through an input/output (I/O) interface 840. Moreover, the electronic device 800 may also communicate with one or more networks (such as a local area network (LAN), a wide area network (WAN), and/or a public network, such as the Internet) through the network adapter 850. As shown in the figure, the network adapter 850 communicates with other modules of the electronic device 800 through the bus 830. It should be understood that although not shown in the figure, other hardware and/or software modules may be used in conjunction with the electronic device 800, including but not limited to: microcode, device drivers, redundant processing units, external disk drive arrays, RAID systems, tape drives and data backup storage systems.

It should be noted that although several modules or units of device for action execution are mentioned in the above detailed description, such division is not mandatory. In fact, according to an implementation of the present disclosure, the features and functions of two or more modules or units described above may be embodied in one module or unit. Conversely, the features and functions of one module or unit described above may be further divided to be embodied by multiple modules or units.

Those skilled in the art can understand that various aspects of the present disclosure may be implemented as a system, method, or program product. Therefore, various aspects of the present disclosure can be embodied in the following forms: a complete hardware implementation, a complete software implementation (including firmware, microcode, etc.), or a combination of hardware and software, which can be collectively referred to as “circuit”, “module’, or “system”. Other embodiments of the present disclosure will be apparent to those skilled in the art from consideration of the specification and practice of the present disclosure disclosed herein. The present disclosure is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

It is to be understood that the present disclosure is not limited to the precise structures described above and illustrated in the accompanying drawings, and various modifications and changes may be made without departing from the scope of the present disclosure. The scope of the disclosure is limited only by the appended claims.

1. A method for adjusting backlight, comprising:
when rendering a current image, determining backlight data corresponding to the current image;
when transmitting the current image, updating, upon transmitting the current image for a first preset duration, the backlight data corresponding to the current image to a backlight driver chip; and
when the updating of the backlight data corresponding to the current image is completed, controlling the backlight driver chip to turn on a backlight source, and adjusting backlight brightness based on the backlight data of the current image.

2. The method for adjusting the backlight according to claim 1, wherein the method further comprises:
determining, based on a refresh rate of the current image, backlight brightness of a next frame image of the current image.

3. The method for adjusting the backlight according to claim 2, wherein the method further comprises:
when a refresh rate of a picture of the current image is updated, compensating the backlight data of the current image, and using the compensated backlight data of the current image as backlight data of the next frame image of the current image.

4. The method for adjusting the backlight according to claim 3, wherein determining, based on the refresh rate of the current image, the backlight brightness of the next frame image of the current image comprises:
acquiring the refresh rate of the picture;
determining a compensation coefficient of the current image based on the refresh rate of the picture and a preset first correspondence, wherein the first correspondence is a correspondence between different refresh rates and different compensation coefficients;
compensating the backlight data of the current image based on the compensation coefficient of the current image; and
determining the backlight brightness of the next frame image of the current image based on the compensated backlight data of the current image.

5. The method for adjusting the backlight according to claim 4, wherein when the refresh rate of the picture of the current image is updated, compensating the backlight data of the current image and using the compensated backlight data of the current image as the backlight data of the next frame image of the current image comprises:
when the refresh rate of the picture changes, saving an updated compensation coefficient of the current image, and setting a flag for updating the compensation coefficient;
when backlight of the current image is interrupted, updating the compensation coefficient of the current image based on the flag;
determining the backlight data corresponding to the current image based on the compensation coefficient of the current image, and updating stored backlight data corresponding to the current image, and clearing the flag when processing is completed; and
when backlight of the next frame image of the current image is interrupted, sending the backlight data corresponding to the current image.

6. The method for adjusting the backlight according to claim 3, wherein determining, based on the refresh rate of the current image, the backlight brightness of the next frame image of the current image comprises:
acquiring the refresh rate of the picture;
updating a frequency of a pulse width modulation signal based on the refresh rate of the picture; and
determining, based on the updated frequency of the pulse width modulation signal, the backlight brightness of the next frame image of the current image.

7. The method for adjusting the backlight according to claim 6, wherein when the refresh rate of the picture of the current image is updated, compensating the backlight data of the current image and using the compensated backlight data of the current image as the backlight data of the next frame image of the current image comprises:
when the refresh rate of the picture changes, saving a frequency of a pulse width modulation signal of the current image, and setting a flag for updating the frequency of the pulse width modulation signal;
when backlight of the current image is interrupted, updating, based on the flag, the frequency of the pulse width modulation signal of the current image;
determining the backlight data corresponding to the current image based on the frequency of the pulse width modulation signal of the current image, updating stored backlight data corresponding to the current image, and clearing the flag after processing is completed; and
when backlight of the next frame image of the current image is interrupted, sending the backlight data corresponding to the current image.

8. The method for adjusting the backlight according to claim 1, wherein when rendering the current image, determining the backlight data corresponding to the current image comprises:
acquiring a captured image of an eye, and determining a gaze area of the eye from the captured image;
defining a gaze area in the current image as a high-definition area, and a remaining area other than the gaze area in the current image as a non-high-definition area, using different layers for the high-definition area and the non-high-definition area, and using different rendering resolutions for rendering different layers; and
calculating backlight data of the rendered layers respectively to obtain two backlight data groups, and combining the two backlight data groups into one backlight data group.

9. The method for adjusting the backlight according to claim 1, wherein the method further comprises:
acquiring a rotation speed of a display device; and
determining a refresh rate of the current image based on the rotation speed and a second correspondence, wherein the second correspondence is a correspondence between a refresh rate level and a rotation speed range.

10. The method for adjusting the backlight according to claim 9, wherein the method further comprises:
determining a rendering resolution of the current image based on the rotation speed and a third correspondence, wherein the third correspondence is a correspondence between a rotation speed range and a reduction ratio of the rendering resolution.

11. The method for adjusting the backlight according to claim 10, wherein the rotation speed range in the second correspondence is the same as or different from the rotation speed range in the third correspondence.

12. A non-transitory computer-readable storage medium having a computer program stored thereon, which, when executed by a processor, implements:
when rendering a current image, determining backlight data corresponding to the current image;
when transmitting the current image, updating, upon transmitting the current image for a first preset duration, the backlight data corresponding to the current image to a backlight driver chip; and
when the updating of the backlight data corresponding to the current image is completed, controlling the backlight driver chip to turn on a backlight source, and adjusting backlight brightness based on the backlight data of the current image.

13. An electronic device, comprising:
a processor; and
a memory configured to store executable instructions of the processor;
wherein the processor is configured to execute:
when rendering a current image, determining backlight data corresponding to the current image;
when transmitting the current image, updating, upon transmitting the current image for a first preset duration, the backlight data corresponding to the current image to a backlight driver chip; and
when the updating of the backlight data corresponding to the current image is completed, controlling the backlight driver chip to turn on a backlight source, and adjusting backlight brightness based on the backlight data of the current image.

14. The electronic device according to claim 13, wherein the electronic device further comprises a display driver chip and a backlight driver chip;
the display driver chip is configured to receive the current image and display the current image on a display screen; and
the backlight driver chip is configured to receive the backlight data corresponding to the current image.

15. (canceled)

16. The electronic device according to claim 13, wherein the processor is further configured to:
determine, based on a refresh rate of the current image, backlight brightness of a next frame image of the current image.

17. The electronic device according to claim 16, wherein the processor is further configured to:
when a refresh rate of a picture of the current image is updated, compensate the backlight data of the current image, and use the compensated backlight data of the current image as backlight data of the next frame image of the current image.

18. The electronic device according to claim 17, wherein the processor is further configured to:
acquire the refresh rate of the picture;
determine a compensation coefficient of the current image based on the refresh rate of the picture and a preset first correspondence, wherein the first correspondence is a correspondence between different refresh rates and different compensation coefficients;
compensate the backlight data of the current image based on the compensation coefficient of the current image; and
determine the backlight brightness of the next frame image of the current image based on the compensated backlight data of the current image.

19. The electronic device according to claim 18, wherein the processor is further configured to:
when the refresh rate of the picture changes, save an updated compensation coefficient of the current image, and set a flag for updating the compensation coefficient;
when backlight of the current image is interrupted, update the compensation coefficient of the current image based on the flag;
determine the backlight data corresponding to the current image based on the compensation coefficient of the current image, and update stored backlight data corresponding to the current image, and clear the flag when processing is completed; and
when backlight of the next frame image of the current image is interrupted, send the backlight data corresponding to the current image.

20. The electronic device according to claim 17, wherein the processor is further configured to:
acquire the refresh rate of the picture;
update a frequency of a pulse width modulation signal based on the refresh rate of the picture; and
determine, based on the updated frequency of the pulse width modulation signal, the backlight brightness of the next frame image of the current image.

21. The electronic device according to claim 20, wherein the processor is further configured to:
when the refresh rate of the picture changes, save a frequency of a pulse width modulation signal of the current image, and set a flag for updating the frequency of the pulse width modulation signal;
when backlight of the current image is interrupted, update, based on the flag, the frequency of the pulse width modulation signal of the current image;
determine the backlight data corresponding to the current image based on the frequency of the pulse width modulation signal of the current image, update stored backlight data corresponding to the current image, and clear the flag after processing is completed; and
when backlight of the next frame image of the current image is interrupted, send the backlight data corresponding to the current image.
